(19) United States
(12) Patent Application Publication
(10) Pub. No.: US 2015/0264502 A1
(43) Pub. Date: Sep. 17, 2015

(54) Audio Signal Processing Device, Position Information Acquisition Device, and Audio Signal Processing System

(71) Applicant: YAMAHA CORPORATION, Hamamatsu-shi, Shizuoka (JP)

(72) Inventors: Ryotaro Aoki, Hamamatsu-shi (JP); Akihiko Suyama, Hamamatsu-shi (JP); Kotaro Nakabayashi, Hamamatsu-shi (JP)

(21) Appl. No.: 14/428,223

(22) PCT Filed: Nov. 15, 2013
(86) PCT No.: PCT/JP2013/080947

§ 371 Date: Mar. 13, 2015

(30) Foreign Application Priority Data
Nov. 16, 2012 (JP) 2012-252523
Nov. 28, 2012 (JP) 2012-260386

(51) Int. Cl. H04S 5/00; H04S 7/00

(52) U.S. Cl. CPC H04S 5/005; H04S 7/303; H04S 7/307; H04S 2400/05; H04S 2400/13; H04S 2420/01

(57) ABSTRACT

An audio signal processing device includes a calculator for generating a plurality of audio signals to be given respectively to a plurality of loudspeakers based on an audio signal corresponding to a virtual sound source having position information. The calculator calculates, with respect to each loudspeaker, a distance between each of the plurality of loudspeakers and the virtual sound source on the basis of position information indicating a position of the virtual sound source and loudspeaker position information indicating positions of the plurality of loudspeakers, and calculates an audio signal corresponding to the virtual sound source to be supplied to each of the plurality of loudspeakers on the basis of the distance.

### TECHNICAL FIELD

The present invention relates to a technique for reproducing sound with a high sense of presence by using a plurality of loudspeakers, and more particularly, it relates to a technique for supporting setting of a position of a loudspeaker and a position of a virtual sound source.

### BACKGROUND ART

As an example of this type of technique, there is a technique for outputting sounds of the same volume and the same phase from two loudspeakers so as to give a listener an auditory sensation as if a sound source is located in the middle of these loudspeakers (namely, so as to localize a sound image in the middle of these loudspeakers). Besides, sound effects through volume change, frequency change and the like are also generally added to give a listener an auditory sensation as if a sound image is moving (an auditory sensation as if a virtual sound source is moving). Conventionally, such a type of technique has been employed mostly in a comparatively large scaled system such as an audio system installed in a movie theater or a theme park, but is recently employed in a home audio system such as a home theater system.

### CITATION LIST

### Patent Document

Patent Document 1: JP-A-2009-065452

### SUMMARY OF INVENTION

### Problems to be Solved by the Invention

In such an audio system capable of reproducing sound with a high sense of presence by using a plurality of loudspeakers, however, a technique for allowing a user to set the position of a virtual sound source or to move the position of the virtual sound source by an intuitive and easy to understand operation has not been conventionally proposed.

The present invention is accomplished in consideration of the aforementioned problem, and a first object of the present invention is, in an audio system including a plurality of loudspeakers, to enable a virtual sound source to be set in a desired position by an intuitive operation, a second object is to enable a virtual sound source to freely move while adding a natural sound effect, and a third object is to realize setting of position information, corresponding to setting of a position of a virtual sound source, in an audio system including a plurality of loudspeakers by an intuitive and easy to understand operation.

### Means for Solving the Problems

In order to solve the above-described problems, the present invention provides an audio signal processing device including: a calculator that generates a plurality of audio signals to be supplied respectively to a plurality of loudspeakers on the basis of an audio signal corresponding to a virtual sound source and having position information, wherein the calculator calculates, on the basis of the position information indicating a position of the virtual sound source and loudspeaker position information indicating positions of the plurality of loudspeakers, a distance between each of the plurality of loudspeakers and the virtual sound source with respect to each of the plurality of loudspeakers, and calculates, on the basis of the distance, the audio signal corresponding to the virtual sound source to be supplied to each of the plurality of loudspeakers.

Besides, in order to solve the above-described problems, the present invention provides a position information acquisition device including: an angle information provider that detects a rotation angle around a vertical axis based on a direction along one of two axes orthogonal to the vertical axis, and outputs angle information indicating the rotation angle; and a position information provider that executes a processing for outputting position information indicating a position on a boundary of a two-dimensional coordinate space, which has a position of the angle information provider as an origin and has a prescribed size orthogonally to the vertical axis, on the basis of the angle information output by the angle information provider every time an operation for instructing position setting is performed, every time a prescribed time has elapsed, or every time the position information is changed.

If this position information acquisition device is used as a terminal for setting a position desired to locate a virtual sound source or an installation position of a loudspeaker in an audio signal processing device, and a person moves to a listening point with the terminal possessed and performs such an intuitive and easy to understand operation of performing an operation for instructing the position setting (of, for example, pressing a prescribed operating element) with the terminal pointed toward a position desired to locate the virtual sound source or toward the loudspeaker, the installation position of the loudspeaker or the position of the virtual sound source can be set in the audio signal processing device.

Besides, the present invention provides an audio signal processing system including: a portable terminal that detects a rotation angle around a vertical axis based on a direction along one of two axes orthogonal to the vertical axis and outputs the rotation angle as angle information; and an audio amplifier including a position information acquirer that acquires position information indicating a position of a virtual sound source taken from a listening point corresponding to a position of a listener set as a position of the portable terminal, and a calculator that generates an audio signal to be supplied to each of a plurality of loudspeakers on the basis of an audio signal corresponding to the virtual sound source and output the audio signal, and executes, in response to acquisition of the position information by the acquirer, a processing for calculating a distribution amount of the audio signal corresponding to the virtual sound source in so that a gain is smaller, in accordance with a position of the loudspeaker, in an audio signal to be supplied to a loudspeaker located in the position farther from a position indicated by the position information, and generates the audio signal to be supplied to each of the plurality of loudspeakers in accordance with the distribution amount, in which the portable terminal executes a processing for transmitting the angle information to the audio amplifier as information indicating the position of the virtual sound source every time an operation for setting the position of the virtual sound source is performed, every time a prescribed time has elapsed, or every time the angle information is changed, the position information acquirer is a communication section that communicates with the portable terminal, converts the angle information received from the portable terminal into coordinate information indicating a position on a boundary of a two-dimensional coordinate space having a position of the portable terminal as an origin and having a prescribed size orthogonally to the vertical axis, and outputs the coordinate information as the position information, and the calculator calculates, on the basis of the position information output from the position information acquirer, a distance between the virtual sound source and each of the plurality of loudspeakers, and calculates a distribution amount of the audio signal corresponding to the virtual sound source in accordance with the distance between the virtual sound source and each of the plurality of loudspeakers.

Also in this audio signal processing system, a user can be allowed to set a position of a virtual sound source or the like by an intuitive and easy to understand operation.

### BRIEF DESCRIPTION OF DRAWINGS

FIG. 1 is a diagram illustrating an example of the constitution of an audio system 1 according to a first embodiment of the present invention.

FIG. 2 is a diagram illustrating an example of loudspeaker arrangement in the audio system 1.

FIG. 3 is a block diagram illustrating an example of the configuration of an audio amplifier 10 included in the audio system 1.

FIG. 4A is a block diagram illustrating an example of the configuration of a portable terminal 20 included in the audio system 1, and FIG. 4B is a diagram illustrating rotation angles of pitch, roll and yaw of the portable terminal 20 around respective rotation axes of three axes X, Y and Z passing through the center of the portable terminal 20 and orthogonal to one another.

FIGS. 5A and 5B are diagrams respectively explaining an example of a loudspeaker position setting screen displayed in a display section of the portable terminal 20 and a method for setting a loudspeaker position by using the portable terminal 20.

FIGS. 6A-6C are diagrams respectively explaining an example of a virtual sound source position setting screen displayed in the display section of the portable terminal 20 and a method for setting a virtual sound source position by using the portable terminal 20.

FIGS. 7A and 7B are diagrams explaining an example of angle/position converting processing executed by an angle/position conversion section 220 of the portable terminal 20.

FIGS. 8A and 8B are diagrams explaining another example of the angle/position converting processing executed by the angle/position conversion section 220 of the portable terminal 20.

FIG. 9 is a diagram explaining movement of a virtual sound source in a third embodiment of the present invention.

FIG. 10 is a diagram illustrating an example of the configuration of a portable terminal 20A according to a modification (1) of the present invention.

FIG. 11 is a diagram illustrating an example of the configuration of an audio amplifier 10A of the modification (1).

### MODE FOR CARRYING OUT THE INVENTION

### A: First Embodiment

### A-1: Constitution of Audio System 1

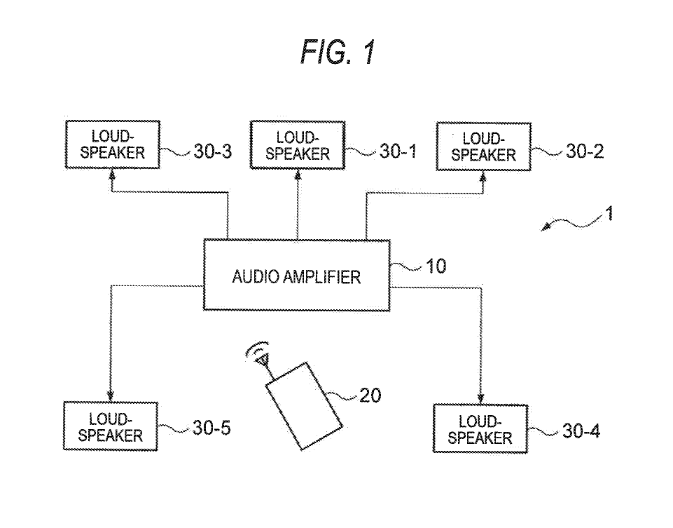

FIG. 1 is a block diagram illustrating an example of the constitution of an audio system (an audio signal processing system) 1 according to a first embodiment of the present invention. The audio system 1 is, for example, a home theater system installed in a living room or the like of a user's house. As illustrated in FIG. 1, the audio system 1 includes an audio amplifier (an audio signal processing device) 10, a portable terminal 20 for operating the audio amplifier 10, and loudspeakers 30-n (n=1 to 5) respectively connected to the audio amplifier 10. Although the audio system 1 also includes, in addition to the equipment illustrated in FIG. 1, for example, a reproducing device for reproducing a video content recorded in a recording medium such as a DVD and outputting a video signal and an audio signal, a display device for displaying an image in accordance with a video signal given through the audio amplifier 10, a subwoofer for reproducing low-pitched sound in accordance with an audio signal supplied through the audio amplifier 10, the reproducing device, the display device and the subwoofer are not illustrated in FIG. 1 because they are little related to the present invention.

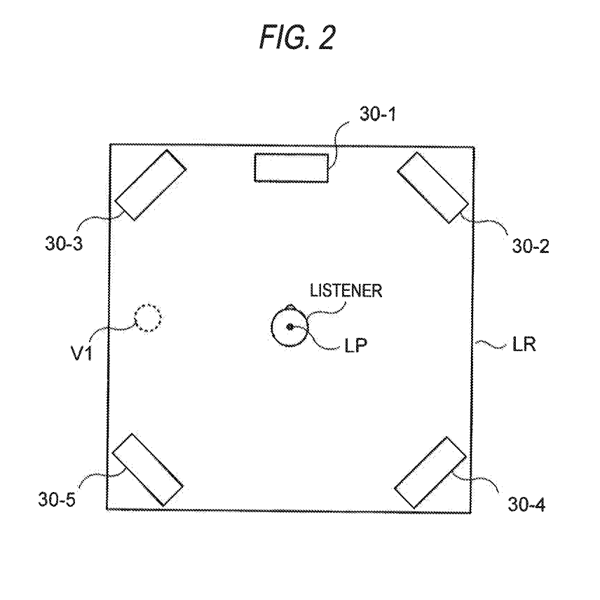

The audio system 1 of FIG. 1 is what is called a 5.1 channel surround system including five loudspeakers and one subwoofer. In the present embodiment, the respective loudspeakers 30-n (n=1 to 5) are arranged in a living room LR of a user of the audio system 1 as illustrated in FIG. 2.

In the present embodiment, audio signals of five channels, that is, a center channel, a right front channel, a left front channel, a right surround channel and a left surround channel, are given from a reproducing device (not shown) to the audio amplifier 10. In the present embodiment, the user can be allowed to generate a virtual sound source for each of these five channels (or a mixing result obtained from arbitrary two or more of these five channels) and to locate the virtual sound source in a desired position (namely, to set the desired position as a position for localizing a sound image corresponding to the audio signal for which the virtual sound source has been generated) by an intuitive and easy to understand operation. For example, when it is instructed through an operation of the portable terminal 20 to locate a virtual sound source V1, which is generated as a virtual sound source for the center channel, in a middle position between the loudspeaker 30-3 and the loudspeaker 30-5 (indicated by a broken line circle in FIG. 2), the audio amplifier 10 outputs an audio signal of the center channel distributedly to the loudspeakers 30-n (n=1 to 5) so that a sound image corresponding to the center channel can be localized in this position. Now, the description will be given mainly on the audio amplifier 10 and the portable terminal 20 remarkably exhibiting characteristics of the present embodiment.

### A-2: Configuration of Audio Amplifier 10

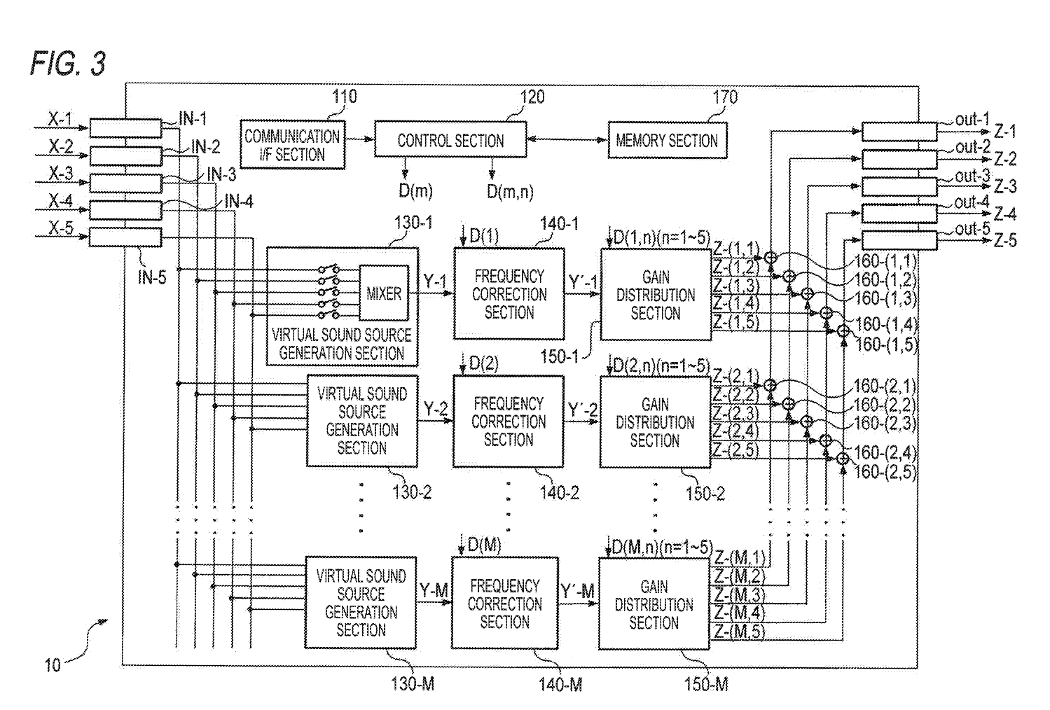

FIG. 3 is a block diagram illustrating an example of the configuration of the audio amplifier 10. The audio amplifier 10 is what is called a multi-channel amplifier, and can set M (M is an arbitrary integer) virtual sound sources at the most by adjusting audio signals supplied to the respective loudspeakers 30-n (n=1 to 5). Hereinafter, a virtual sound source identified by a serial number m is sometimes mentioned as a “virtual sound source Vm”. As illustrated in FIG. 3, the audio amplifier 10 includes audio input terminals IN-k (k=1 to 5), audio output terminals OUT-n (n=1 to 5), a communication interface section (indicated as a “communication I/F section” in FIG. 3, which also applies to the following description) 110, a control section 120, virtual sound source generation sections 130-m (m=1 to M), frequency correction sections 140-m (m=1 to M), gain distribution sections 150-m (m=1 to M), adders 160-(j, n) (j=1 to M−1), and a memory section 170. In the present embodiment, among from the constituting elements of the audio amplifier 10 illustrated in FIG. 3, the virtual sound source generation sections 130-m (m=1 to M), the frequency correction sections 140-m (m=1 to M), the gain distribution sections 150-m (m=1 to M), and the adders 160-(j, n) (j=1 to M−1) are realized through software processing performed by a DSP (Digital Signal Processor), but it goes without saying that these constituting elements may be mounted as hardware such as an electronic circuit.

The audio input terminals IN-k (k=1 to 5) are connected to the reproducing device (not shown) via signal lines of audio cables or the like. To the audio input terminals IN-k (k=1 to 5), audio signals X-k output from the reproducing device (not shown in FIG. 1) are respectively given. In the present embodiment, the audio signal X-1 corresponds to an audio signal of the center channel. The audio signal X-2 corresponds to an audio signal of the right front channel. The audio signal X-3 corresponds to an audio signal of the left front channel. The audio signal X-4 corresponds to an audio signal of the right surround channel. The audio signal X-5 corresponds to an audio signal of the left surround channel. The audio output terminals OUT-n (n=1 to 5) are respectively connected to the loudspeakers 30-n via signal lines of audio cables or the like. The serial number k used for uniquely identifying each of the audio input terminals IN-k (k=1 to 5) plays a role of a channel identifier for uniquely indicating a channel corresponding to an audio signal input to the audio input terminal IN-k. Similarly, the serial number n for uniquely identifying each of the audio output terminals OUT-n (n=1 to 5) plays a role of a loudspeaker identifier for uniquely indicating the loudspeaker 30-n connected to the audio output terminal OUT-n.

The communication I/F section 110 is, for example, a NIC (Network Interface Card), and is connected to a network router (not shown in FIG. 1) of a LAN (Local Area Network) installed in the house of the user of the audio system 1. The communication I/F section 110 receives, via the network router, information transmitted from the portable terminal 20, and delivers the received information to the control section 120. In the present embodiment, a combination of a loudspeaker identifier described above and position information corresponding to the installation position of a loudspeaker 30-n identified by the loudspeaker identifier is transmitted from the portable terminal 20 as well as a combination of a channel identifier of a channel for generating a virtual sound source, a virtual sound source identifier uniquely indicating the generated virtual sound source and position information corresponding to the installation position of the virtual sound source is transmitted from the portable terminal 20, which will be described in detail later. In the present embodiment, as the position information corresponding to the installation position of the loudspeaker 30-n, coordinate information corresponding to coordinates of the installation position of the loudspeaker 30-n in a two-dimensional coordinate space having a position of a listening point LP of FIG. 2 as the coordinate origin and having a prescribed size orthogonally to a vertical axis (or a three-dimensional coordinate space having a prescribed size further in a height direction along the vertical axis) is used. Also for the position information corresponding to the installation position of a virtual sound source, coordinate information corresponding to coordinates of the installation position of the virtual sound source in the same two-dimensional coordinate space (or three-dimensional coordinate space) is similarly used.

The control section 120 is, for example, a CPU (Central Processing Unit), and the memory section 170 is, for example, a hard disc. In the memory section 170, a loudspeaker management table and a virtual sound source management table are precedently stored (both of which are not shown in FIG. 2). In the loudspeaker management table, a loudspeaker identifier and position information received from the portable terminal 20 are stored in correspondence with each other. In the virtual sound source management table, a virtual sound source identifier, a channel identifier and position information received from the portable terminal 20 are stored in correspondence with one another. The control section 120 executes the following processing in accordance with a control program stored in a ROM (Read Only Memory: not shown in FIG. 2). The first processing is processing for writing, in the loudspeaker management table, a combination of a loudspeaker identifier and position information received from the portable terminal 20. The second processing is processing for writing, in the virtual sound source management table, a combination of a virtual sound source identifier, a channel identifier and position information received from the portable terminal 20. The third processing is processing for calculating, with respect to each virtual sound source Vm, a value D(m) corresponding to a distance between the virtual sound source Vm and the listening point LP (that is, the origin of the coordinate space as described above) in the above-described coordinate space on the basis of the contents stored in the virtual sound source management table and for giving the calculated value to the frequency correction section 140-m. The fourth processing is processing for calculating, with respect to each virtual sound source Vm, a value D(m, n) corresponding to a distance between each of the loudspeakers 30-n (n=1 to 5) and the virtual sound source Vm in the above-described coordinate space on the basis of the contents stored in the loudspeaker management table and the contents stored in the virtual sound source management table, and for giving the calculated value to the gain distribution section 150-m.

The virtual sound source generation section 130-m generates, from an audio signal X-k given through each of the audio input terminals IN-k (k=1 to 5), an audio signal Y-m of the mth virtual sound source (a virtual sound source having a virtual sound source identifier m) and outputs the generated audio signal. More specifically, the virtual sound source generation section 130-m generates the audio signal Y-m by mixing audio signals, among from the audio signals X-k (k=1 to 5), corresponding to a channel identifier stored in the virtual sound source management table in correspondence with the virtual sound source identifier m, and gives the generated audio signal to the frequency correction section 140-m. The virtual sound source generation section 130-m includes switches for selecting audio signals to be mixed, and a mixer for mixing audio signals selected through on/off control of the switches (although the mixer and the switches of merely the virtual sound source generation section 130-1 are illustrated in FIG. 3). The on/off control of these switches is performed by the control section 120 on the basis of the contents stored in the virtual sound source management table. For example, if the channel identifier corresponding to the center channel is stored in the virtual sound source management table in correspondence with a virtual sound source identifier corresponding to a first virtual sound source, the control section 120 turns on merely a switch corresponding to the center channel (namely, the audio signal X-1) and turns off the other switches among from the switches included in the virtual sound source generation section 130-1.

The frequency correction section 140-m performs, on the audio signal Y-m, signal processing for attenuating a high frequency component more largely as the value D(m) given from the control section 120 is larger, and gives an audio signal Y′-m resulting from the signal processing to the gain distribution section 150-m. As described above, the value D(m) corresponds to the distance between the virtual sound source Vm and the listening point LP. The frequency correction section 140-m functions, together with the control section 120 calculating the value D(m), as an adjuster for recreating acoustic characteristics that attenuation of a high frequency component is larger as a distance from a sound source to a listening point is larger. Incidentally, the relationship between the distance from a virtual sound source to a listening point and the attenuation of each frequency component (that is, the contents of the signal processing performed by the frequency correction section 140-m) may be determined based on experiments appropriately performed.

If none of the values D(m, n) (n=1 to 5) is sufficiently smaller than a prescribed threshold value to be regarded as zero, the gain distribution section 150-m generates an audio signals Z-(m, n) to be supplied to the respective loudspeakers 30-n (n=1 to 5) by distributing the audio signal Y′-m so that a gain ratio of each of the resulting signals can be an inverse ratio of the value D(m, n), and outputs the generated signals. On the other hand, if any of the values D(m, n) can be regarded as zero (for example, if the position of any of the loudspeakers 30-m or a position in the vicinity of any of the loudspeakers 30-m is set as the position of the virtual sound source Vm), the gain distribution section 150-m distributes the audio signal in such a manner that an audio signal Z-(m, m)=the audio signal Y′-m and the audio signal Z-(m, n) (n≠m)=0. The adder 160-(j, n) (j=1 to M−1) generates an audio signal Z-n to be supplied to the loudspeaker 30-n by adding the audio signals Z-(m, n) (m=1 to M), and gives the generated signal to the audio output terminal OUT-n. Since the audio output terminal OUT-n is connected to the loudspeaker 30-n, the audio signal Z-n resulting from the signal processing performed by the audio amplifier 10 is supplied to the loudspeaker 30-n. Therefore, in the present embodiment, sound in accordance with the audio signal Z-n is emitted from the loudspeaker 30-n.

If none of the values D(m, n) (n=1 to 5) can be regarded as zero, the audio signals Z-(m, n) are generated by distributing the audio signal Y′-m corresponding to the virtual sound source Vm so that a gain ratio of each of the resulting signals can be an inverse ratio of the value D(m, n) because a sound field as if sound is emitted from a place set as the position of the virtual sound source Vm can be thus formed. In the case where the position in the middle of the loudspeaker 30-3 and the loudspeaker 30-5 is set as the position of the virtual sound source V1 as illustrated in FIG. 2, however, if the audio signal Y′-m corresponding to the virtual sound source Vm is distributed in accordance with an inverse ratio of the distance between this position and each of the loudspeakers 30-n, the audio signal is too much distributed to the loudspeaker 30-2 and the loudspeaker 30-4, which may result in poor sound separation in some cases. Therefore, the distribution may be performed by using an inverse ratio of a second or fourth power of each of the distances D(m, n) so that a distribution amount can be smaller (the gain can be smaller) in a loudspeaker farther from the virtual sound source, and the multiplier may be changed in accordance with the distance. Alternatively, correction may be performed by using a correction function for reducing the gain distribution in accordance with the distance.

It is assumed that the positions of the loudspeakers 30-n (n=1 to 5) are set in the two-dimensional coordinate space having the listening point LP as the origin, and that the position in the middle of the loudspeaker 30-3 and the loudspeaker 30-5 of FIG. 2 is set as the position of the virtual sound source V1. In this case, the position of the sound can be clearly expressed by performing the gain distribution so that the gain of loudspeakers disposed on the side of the listening point LP opposite to the virtual sound source V1 (namely, the loudspeakers 30-2 and 30-4 in the example of FIG. 2) can be approximately −40 dB. Besides, in the case where loudspeakers are arranged respectively at four corners in the vicinity of the ceiling and four corners in the vicinity of the floor of a living room of the user and the position of a virtual sound source is to be set in a three-dimensional coordinate space having the listening point LP as the origin, the gain distribution may be performed so that the gain of a loudspeaker disposed on the counter side in consideration of the height direction (for example, if the virtual sound source is set in the middle of the two loudspeakers disposed at the corners in the vicinity of the ceiling on the left side wall, the two loudspeakers disposed at the corners in the vicinity of the floor on the right side wall) can be approximately −60 dB.

The configuration of the audio amplifier 10 has been thus described.

### A-3: Configuration of Portable Terminal 20

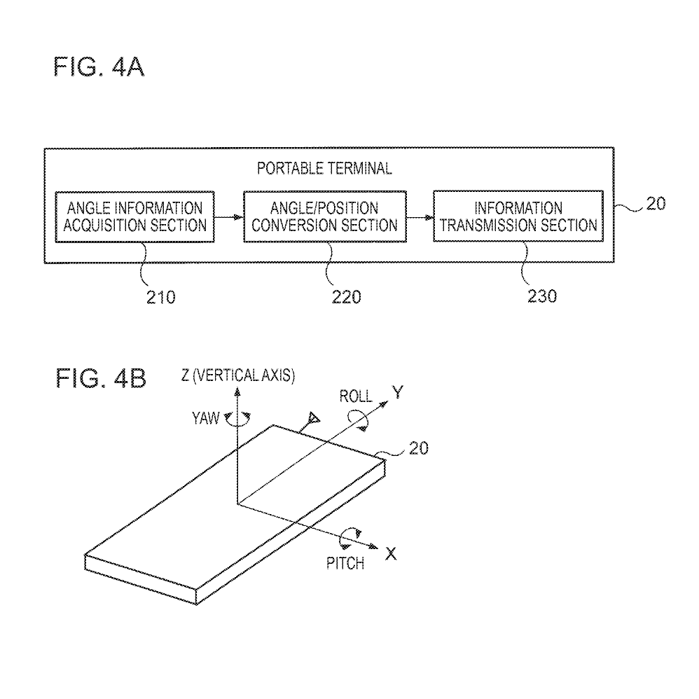

FIG. 4(a) is a block diagram illustrating an example of the configuration of the portable terminal 20. As illustrated in FIG. 4(a), the portable terminal 20 includes an angle information acquisition section 210, an angle/position conversion section 220 and an information transmission section 230. The portable terminal 20 of the present embodiment is what is called a smart phone, and includes, in addition to the constituting elements illustrated in the drawing, a voice communication section and a user interface section such as a touch panel and a liquid crystal display, but the constituting elements other than those illustrated in FIG. 4(a) are neither illustrated in the drawing nor described in detail because they are little related to the present invention.

The angle information acquisition section 210 detects rotation angles of pitch, roll and yaw of the portable terminal 20 around rotation axes of three axes X, Y and Z (specifically, the Z axis is an axis in the vertical direction and the X axis is an axis in a widthwise direction of the portable terminal 20 in this embodiment as illustrated in FIG. 4(b)) passing through the center of the portable terminal 20 (for example, the center of gravity of the portable terminal 20) and orthogonal to one another, and outputs, as information corresponding to the attitude of the portable terminal 20, angle information corresponding to these three angles. As the angle information acquisition section 210, a gyro sensor may be used, or a combination of a triaxial acceleration sensor and a conversion section for converting acceleration detected by the acceleration sensor into the above-described angles or a combination of an angle sensor and a gyro sensor may be used. Incidentally, in order to improve the accuracy in detecting the angles by the angle information acquisition section 210, the angle information acquisition section 210 is preferably provided at the center of the portable terminal 20 (or in the vicinity of the center of the portable terminal 20).

The angle/position conversion section 220 is a software module realized by a control section (such as a CPU) of the portable terminal 20. In response to an operation for setting the position of a loudspeaker 30-n or the position of a virtual sound source Vm performed in an operation section (not shown), the angle/position conversion section 220 converts the angle information given from the angle information acquisition section 210 into coordinate information corresponding to a position in a coordinate space with a prescribed size having the position of the center of the portable terminal 20 as the coordinate origin (namely, position information of the present invention), and gives the converted information to the information transmission section 230. Incidentally, a specific method for converting the angle information into the position information performed by the angle/position conversion section 220 will be disclosed later. The information transmission section 230 is a wireless communication circuit for transmitting data to the audio amplifier 10 via the network router. In other words, the angle/position conversion section 220 and the information transmission section 230 together function as a position information provider for executing, every time an operation for instructing to set a virtual sound source position or the like is performed, processing for outputting, on the basis of the angle information output by the angle information acquisition section 210, the coordinate information corresponding to the position on a boundary of a coordinate space with a prescribed size having the position of the portable terminal 20 as the origin (that is, a two-dimensional coordinate space orthogonal to the vertical axis, or a three-dimensional coordinate space further having a height direction along the vertical axis, which will be described in detail later). Incidentally, in another preferable aspect, the angle/position conversion section 220 and the information transmission section 230 may be caused to function as a position information provider for executing, every time a prescribed time has elapsed or every time the position information is changed, processing for outputting the position information (the coordinate information) on the basis of the angle information output by the angle information acquisition section 210, and such an aspect will be described in detail later. In the present embodiment, owing to the operations of the angle information acquisition section 210, the angle/position conversion section 220 and the information transmission section 230, a combination of a loudspeaker identifier and position information corresponding to the installation position of a loudspeaker identified by the loudspeaker identifier, or a combination of a channel identifier of a channel for generating a virtual sound source, position information corresponding to the installation position of the virtual sound source and a virtual sound source identifier of the virtual sound source is transmitted to the audio amplifier 10.

In the case where the installation position of a loudspeaker 30-n or the installation position of a virtual sound source Vm is to be set by using the portable terminal 20, a user first stands in the position of the listening point LP with the portable terminal 20 held in his/her hand, and presses a reset button with the Y-axis of the portable terminal 20 pointed in a reset direction (that is, a direction toward the loudspeaker 30-1 in the present embodiment). When the press of the rest button is detected, the angle information acquisition section 210 resets the yaw angle to zero. Next, if the user desires to set the installation position of a loudspeaker, the user starts a program to set a loudspeaker position by operating the operation section (not shown) of the portable terminal 20, and if the user desires to set the installation position of a virtual sound source Vm, the user starts a program to set a virtual sound source position by operating the operation section (not shown) of the portable terminal 20.

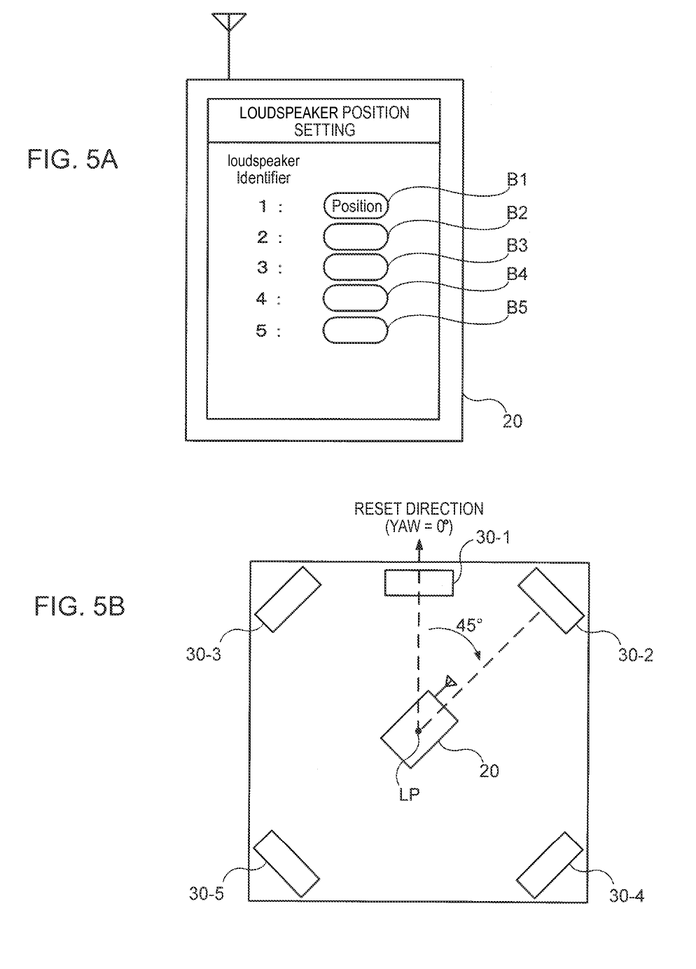

When the setting of the loudspeaker position is started, the portable terminal 20 displays a loudspeaker position setting screen as illustrated in FIG. 5(a) in a display section (not shown). As illustrated in FIG. 5(a), in the loudspeaker position setting screen, buttons Bn (that is, virtual operating elements realized by the touch panel in the present embodiment) for allowing a user to instruct the setting of the position correspondingly to the loudspeaker identifier n of each loudspeaker 30-n (n=1 to 5) are provided. For example, if the installation position of the loudspeaker 30-2 of FIG. 2 is to be set, the user may perform an operation of pointing the Y-axis of the portable terminal 20 in a state of displaying the loudspeaker position setting screen in the direction toward the loudspeaker 30-2 (which is the direction of the yaw angle=450 in the present embodiment: see FIG. 5(b)) and pressing a button B2 corresponding to the loudspeaker 30-2. When such an operation is performed, the portable terminal 20 transmits, to the audio amplifier 10 by using the information transmission section 230, a combination of the loudspeaker identifier corresponding to the pressed button B2 and position information obtained by converting the angle information, obtained when this operation is performed, by the angle/position conversion section 220. Similarly, if the installation position of a loudspeaker 30-n (n=1 or 3 to 4) is to be set, a button Bn may be pressed with the Y-axis of the portable terminal 20 in a state of displaying the loudspeaker position setting screen pointed toward the loudspeaker 30-n.

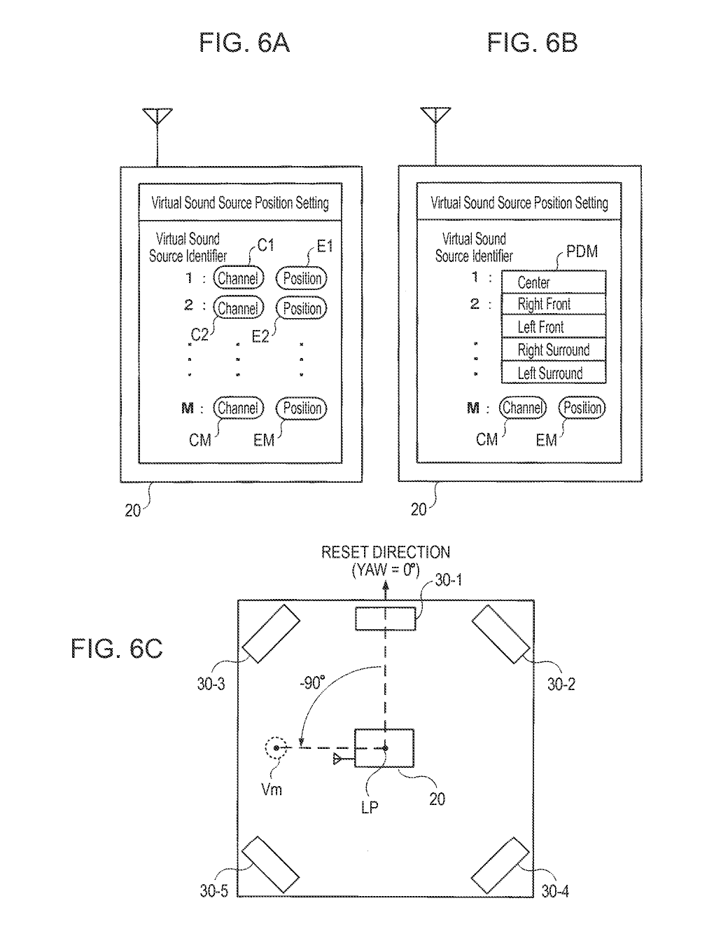

FIG. 6(a) is a diagram illustrating an example of a virtual sound source position setting screen displayed in the display section (not shown) by the portable terminal 20 when the setting of a virtual sound source position is started. As illustrated in FIG. 6(a), in the virtual sound source position setting screen, buttons Cm for allowing a user to select a channel for generating a virtual sound source correspondingly to a virtual sound source identifier m (m=1 to M), and buttons Em for allowing the user to select a position of the virtual sound source corresponding to the virtual sound source identifier are provided. For example, in the case where it is desired to generate a virtual sound source of the center channel as the virtual sound source V1 and to locate the virtual sound source V1 in a middle position between the loudspeaker 30-3 and the loudspeaker 30-5, the user may perform the following operation: In the same manner as in the case of the setting of a loudspeaker position, with the Y-axis of the portable terminal 20 in a state of displaying the virtual sound source position setting screen pointed toward a position desired to locate the virtual sound source (for example, a direction of the yaw angle=−90′: see FIG. 6(c)), the user presses a button C1. Then, as illustrated in FIG. 6(b), a pull-down menu PDM for channel selection is displayed. The user selects a channel for generating a virtual sound source (that is, the center channel in this example) by performing an operation on the pull-down menu PDM. Next, the user presses a button E1. When such an operation is performed, the portable terminal 20 transmits, to the audio amplifier 10 by the information transmission section 230, a combination of the virtual sound source identifier corresponding to the pressed buttons C and E1, the channel identifier selected by the operation performed on the pull-down menu PDM, and position information obtained by converting, by the angle/position conversion section 220, angle information obtained at the time of pressing the button E1.

### A-4: Method for Setting Loudspeaker Position and the Like in Present Embodiment

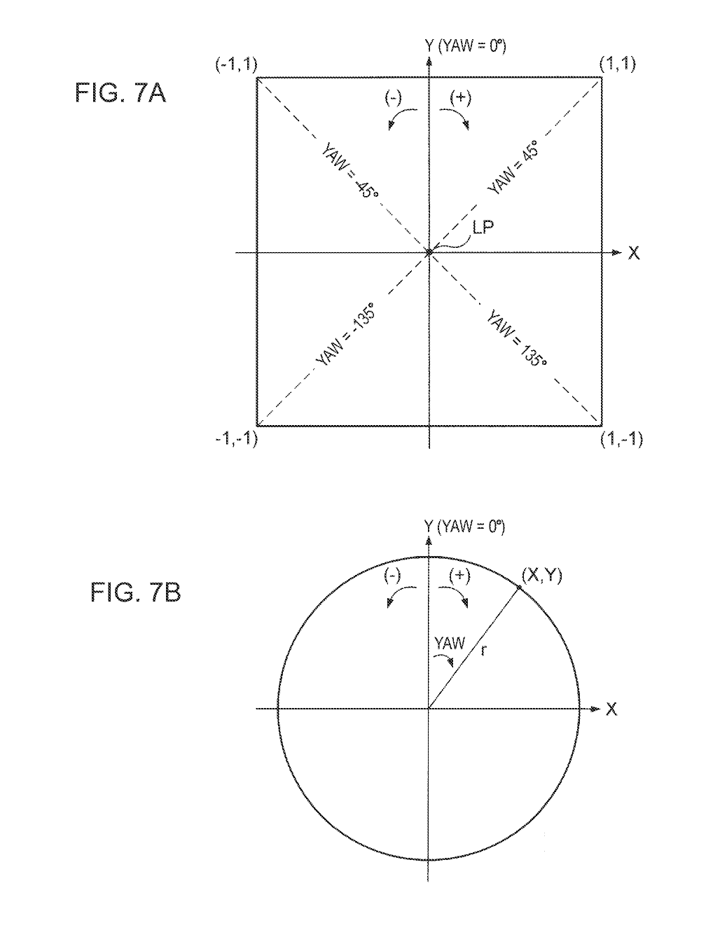

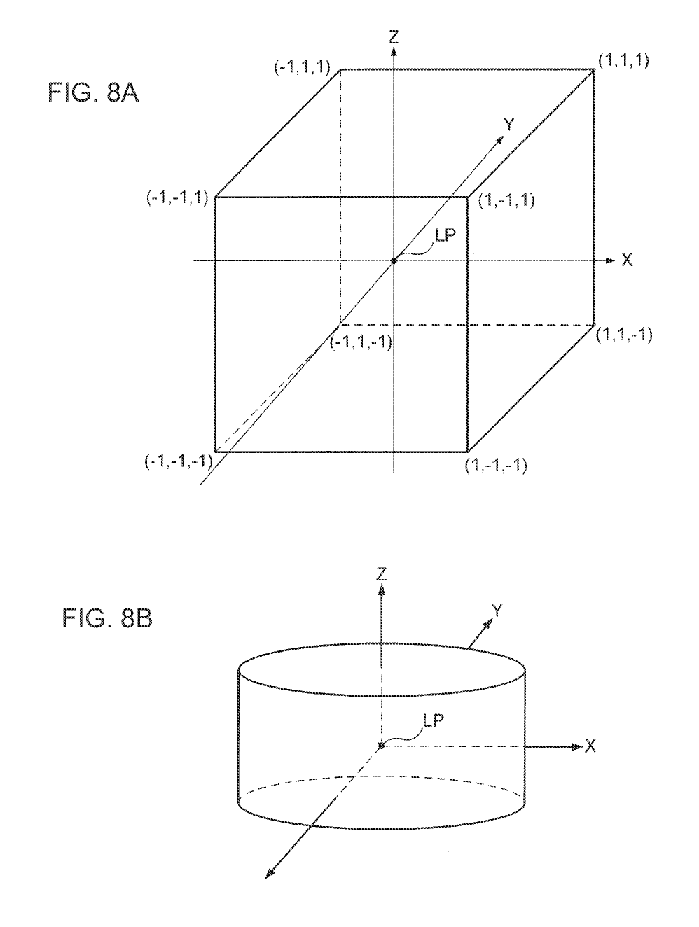

Next, angle/position converting processing executed by the angle/position conversion section 220 will be described with reference to FIGS. 7 and 8. FIG. 7 is a diagram for explaining a method for setting a virtual sound source position and a loudspeaker position in a two-dimensional coordinate space with a prescribed size having the center of the portable terminal 20 as the coordinate origin. On the other hand, FIG. 8 is a diagram for explaining a method for setting a virtual sound source position and a loudspeaker position in a three-dimensional coordinate space with a prescribed size having the center of the portable terminal 20 as the coordinate origin.

(A-4-1: Position Setting in Two-Dimensional Coordinate Space)

In case of setting a virtual sound source position and a loudspeaker position in a two-dimensional coordinate space having the center of the portable terminal 20 as the coordinate origin, the angle/position conversion section 220 calculates position information (X, Y) by using merely the yaw angle out of the angle information output by the angle information acquisition section 210 as illustrated in FIG. 7(a) or 7(b). As described above, since a user desiring to set a virtual sound source position and a loudspeaker position stands in the position of the listening point LP with the portable terminal 20 held in his/her hand, the position of the center of the portable terminal 20 substantially accords with the position of the listening point LP. Accordingly, the position of the listening point LP substantially accords with the coordinate origin of the two-dimensional coordinate space.

FIG. 7(a) is a diagram for explaining an operation performed in a case where a virtual sound source position and a loudspeaker position are to be set in a two-dimensional coordinate space having the center of the portable terminal 20 as the coordinate origin and having a rectangular shape with a length along the Y-axis direction of 2 and a length along the X-axis direction of also 2. In this case, if the value of the yaw angle is −45° to 45°, the angle/position conversion section 220 sets X to −1 to 1 in accordance with the value of the yaw angle and sets Y to 1. Alternatively, if the value of the yaw angle is 45° to 135°, the angle/position conversion section 220 sets Y to +1 to −1 in accordance with the value of the yaw angle and sets X to 1. Alternatively, if the value of the yaw angle is −45° to −135°, the angle/position conversion section 220 sets Y to +1 to −1 in accordance with the value of the yaw angle and sets X to −1. Besides, if the value of the yaw angle is 135° to 180°, the angle/position conversion section 220 sets X to 1 to 0 in accordance with the value of the yaw angle and sets Y to −1, and if the value of the yaw angle is −135° to −180°, it sets Y to −1 to 0 in accordance with the value of the yaw angle and sets Y to −1. Specifically, the angle information output by the angle information acquisition section 210 is converted into coordinates (X, Y) on a boundary of the rectangular two-dimensional coordinate space illustrated in FIG. 7(a). FIG. 7(b) is a diagram for explaining an operation performed in a case where a virtual sound source position and a loudspeaker position are to be set in a two-dimensional coordinate space having the center of the portable terminal 20 as the coordinate origin and having a radius r. In this case, the angle/position conversion section 220 sets X to r×sin(yaw) and Y to r×cos(yaw). Specifically, the angle information output by the angle information acquisition section 210 is converted into coordinates (X, Y) on a circumference having the radius r as illustrated in FIG. 7(b).

(A-4-2: Position Setting in Three-dimensional Coordinate Space)

In case of setting a virtual sound source position and a loudspeaker position in a three-dimensional coordinate space with a prescribed size having the center of the portable terminal 20 as the coordinate origin, after obtaining the coordinates on the X-axis and the Y-axis in the above-described manner, a coordinate Z along the height direction may be obtained by using the pitch angle. Specifically, if the value of the pitch angle is −45° to 45°, Z may be set to −1 to 1 in accordance with the value of the pitch angle, if the value of the pitch angle is smaller than −45°, Z may be set to −1, and if the value of the pitch angle is larger than 45°, Z may be set to +1. According to this aspect, the angle information output by the angle information acquisition section 210 is converted into a position (X, Y, Z) on a side surface of a three-dimensional coordinate space in a cubic shape as illustrated in FIG. 8(a) or on a side surface of a three-dimensional coordinate space in a cylindrical shape as illustrated in FIG. 8(b). Alternatively, the angle information may be converted into a position (X, Y, Z) on the ceiling or the bottom of the three-dimensional coordinate space of FIG. 8(a) or 8(b) as follows: If the value of the pitch angle is 45° to 90°, Z is set to 1, and X and Y having been obtained as described with reference to FIG. 7(a) or 7(b) are multiplied by (90−pitch angle)/45, and if the value of the pitch angle is −45° to −90°, Z is set to −1, and X and Y having been obtained as described with reference to FIG. 7(a) or 7(b) are multiplied by (pitch angle+90)/45. Alternatively, the angle information output by the angle information acquisition section 210 may be converted into coordinates (X, Y, Z) on a spherical surface with a radius r by setting X to r×sin(pitch)×cos(yaw), Y to r×sin(pitch)×cos(yaw) and Z to r×cos(pitch).

It is assumed, for example, that the loudspeakers 30-n (n=1 to 5) are respectively installed as illustrated in FIG. 2 and that the setting method for the two-dimensional coordinate space as illustrated in FIG. 7(a) is employed as the method for setting a loudspeaker position and the like. In this case, the direction toward the loudspeaker 30-1 taken from the listening point LP is the reset direction, and hence, in setting the position of the loudspeaker 30-1, the value of the yaw angle corresponding to the angle information output by the angle information acquisition section 210 is 0 (zero), and the angle/position conversion section 220 converts this angle information into position information (0, 1) and gives this information to the information transmission section 230. In setting the position of the loudspeaker 30-2, since the direction toward the loudspeaker 30-2 taken from the listening point LP is a direction at +45° against the reset direction, the value of the yaw angle corresponding to the angle information output from the angle information acquisition section 210 is 45°. Therefore, the angle/position conversion section 220 converts this angle information into position information (1, 1) and gives this information to the information transmission section 230.

Here, it should be noted that although the position information transmitted from the portable terminal 20 in the present embodiment corresponds to the virtual sound source position or the loudspeaker position in the two-dimensional (or three-dimensional) coordinate space with a prescribed size having the center of the portable terminal 20 as the coordinate origin, the relative positional relationship among the virtual sound source position, the loudspeaker position and the listening point position in the coordinate space substantially accords with the relative positional relationship between the virtual sound source position, the loudspeaker position and the listening point position in the user's living room. Therefore, each ratio between the values D(m) and D(m, n) calculated on the basis of the position information transmitted from the portable terminal 20 substantially accords with each ratio in the distance between the listening point LP and the virtual sound source Vm and in the distance between the virtual sound source Vm and the loudspeaker 30-n in the living room. Accordingly, there arises no problem even when the gain distribution and the frequency correction are performed on the basis of the values D(m) and D(m, n). Incidentally, it is preferable to appropriately perform the above-described reset operation for avoiding occurrence of large divergence between the relative positional relationship among the virtual sound source position, the loudspeaker position and the listening point position in the coordinate space and the relative positional relationship among the virtual sound source position, the loudspeaker position and the listening point position in the user's living room.

### A-5: Effects of Present Embodiment

As described so far, in the present embodiment, the position of a loudspeaker 30-n can be set in the audio amplifier 10 by the intuitive operation of pressing a button Bn with the Y-axis of the portable terminal 20 in a state of displaying the loudspeaker position setting screen pointed toward the loudspeaker 30-n. Similarly, a channel for generating a virtual sound source as the virtual sound source Vm and the installation position of the virtual sound source Vm can be set in the audio amplifier 10 by the intuitive operation of selecting the channel for generating a virtual sound source as the virtual sound source Vm and pressing a button Em with the Y-axis of the portable terminal 20 in a state of displaying the virtual sound source position setting screen pointed toward a position desired to locate the virtual sound source Vm.

When a virtual sound source can be set by an intuitive and easy to understand operation, persons in any positions in the living room LR of FIG. 2 can be allowed to comfortably view image contents by the intuitive and easy to understand operation. For example, under situations where the respective loudspeakers are arranged as illustrated in FIG. 2 and the audio signals X-k (k=1 to 5) are respectively supplied to the loudspeakers 30-k, a person sitting in a position away from the loudspeaker 30-1, that is, the output loudspeaker of the center channel, such as a person sitting in the vicinity of the loudspeaker 30-5, may have difficulty to catch sound output from the loudspeaker 30-1 in some cases. The only one conventional method for coping with such a case is increase of the sound volume of the center channel, but there arises a problem in which the sound thus increased becomes too large for a person sitting in the vicinity of the loudspeaker 30-1. On the contrary, in the present embodiment, a virtual sound source can be generated for the center channel to be located in the middle between the loudspeaker 30-3 and the loudspeaker 30-5 by the intuitive and easy to understand operation, and hence, persons sitting in all positions can be allowed to comfortably view image contents without increasing the volume of the sound output from the loudspeaker 30-1.

Besides, in the present embodiment, in case of reproducing, for example, a movie, if a speech component is allocated to a presence loudspeaker installed in a high position on a front side for locating the speech component in a position where a character appearing in an image displayed on a television or a projector speaks, a user can be provided with an auditory sensation as if the speech is produced from the mouth of the character appearing in the image, and thus, more realistic sound with a higher sense of presence can be reproduced. Furthermore, the sense of presence can be adjusted in accordance with a user's taste by, for example, locating surround sound (sound of the right surround channel or the left surround channel) outside the original position in a quiet scene of a movie, or by locating the surround sound closer than the original position in a battle scene or the like. Similarly, a user can be allowed to make minor adjustment by locating, for example, a virtual sound image corresponding to the sound of a left front loudspeaker L in a middle position between the left front loudspeaker L and a left surround loudspeaker SL. In addition, if a plurality of positions in the vicinity of the position of the loudspeaker 30-1 are set, in addition to the position of the loudspeaker 30-1, as the position of the virtual sound source corresponding to the audio signal X-1, the magnitude of the virtual sound source (sound image) of the center channel can be controlled.

Besides, in the present embodiment, the position information corresponding to the installation positions of the respective loudspeakers 30-n (n=1 to 5) and the position information for locating the respective virtual sound sources Vm (m=1 to M) are stored in the memory section 170, and the gain distribution and the frequency correction are performed on the basis of the memory contents. Therefore, in the case where the installation positions of the loudspeakers are to be changed due to rearrangement of the living room but the positions of the respective virtual sound sources Vm (m=1 to M) are not desired to be changed, the installation positions of the loudspeakers alone may be set again. This is because if new installation positions of the loudspeakers are set by using the portable terminal 20, the audio amplifier 10 executes the gain distribution and the frequency correction on the basis of the new loudspeaker positions and the prior positions of the virtual sound sources Vm so that the virtual sound sources Vm can be located in the prior positions.

### B: Second Embodiment

In the first embodiment described above, the description is given on a case where image contents such as a movie are reproduced by the audio system 1, that is, the 5.1 channel surround system including the loudspeakers 30-n (n=1 to 5) and the subwoofer (not shown in FIG. 1). Audio signals input to the audio amplifier 10 are, however, not limited to audio signals constituting one image content. For example, a plurality of types of audio signals respectively corresponding to different contents may be input to the audio amplifier 10, and virtual sound sources corresponding to the respective contents may be located in positions set by a user. Specifically, an audio signal of sound of a television program and an audio signal of a music reproduced by a music player are input to the audio amplifier 10, and a user is allowed to set, through an operation of the portable terminal 20, a position for locating a virtual sound source corresponding to the sound of the television program and a position for locating a virtual sound source corresponding to the music reproduced by the music player.

It is assumed, for example, that the position of a table placed in a living room where the audio system 1 is installed is set as the position of the virtual sound source corresponding to the music reproduced by the music player, and that a position in the vicinity of a kitchen is set as the position of the virtual sound source corresponding to the sound of the television program. Then, the user can listen to the music reproduced by the music player at the table and can listen to the sound of the television in the kitchen. In other words, the user can listen to an arbitrary sound in every area in his/her house. Besides, if sounds corresponding to the same sound source are emitted, with the phase shifted, from loudspeakers arranged in different positions, due to the interference among the sounds emitted from the respective loudspeakers, there arise a position where the sound from the sound source is strongly caught and a position where the sound is weakly caught. Accordingly, if the phase difference and the like are appropriately adjusted, different persons can be allowed to listen to sounds from different sound sources without disturbing one another.

### C: Third Embodiment

Movement of a virtual sound source may be realized by allowing a user to successively set a plurality of positions for one virtual sound source as a position for locating the virtual sound source and changing, over time, gain distribution obtained by the gain distribution section 150-m in accordance with information successively transmitted from the portable terminal 20 (namely, a combination of a virtual sound source identifier, a channel identifier and position information). For example, in the case where the position of the virtual sound source Vm is set by calculating a position (X, Y, Z) on the bottom of the three-dimensional coordinate space of FIG. 8(a) on the basis of the yaw and pitch angles acquired by the angle information acquisition section 210, it is assumed that sound reproduction is started after the position of the virtual sound source Vm is set by the operation performed on the virtual sound source setting screen described above with the Y-axis of the portable terminal 20 pointed toward a position X0 (a position where yaw=−90° and pitch=θ0 (wherein −90°<θ0<−45°)).

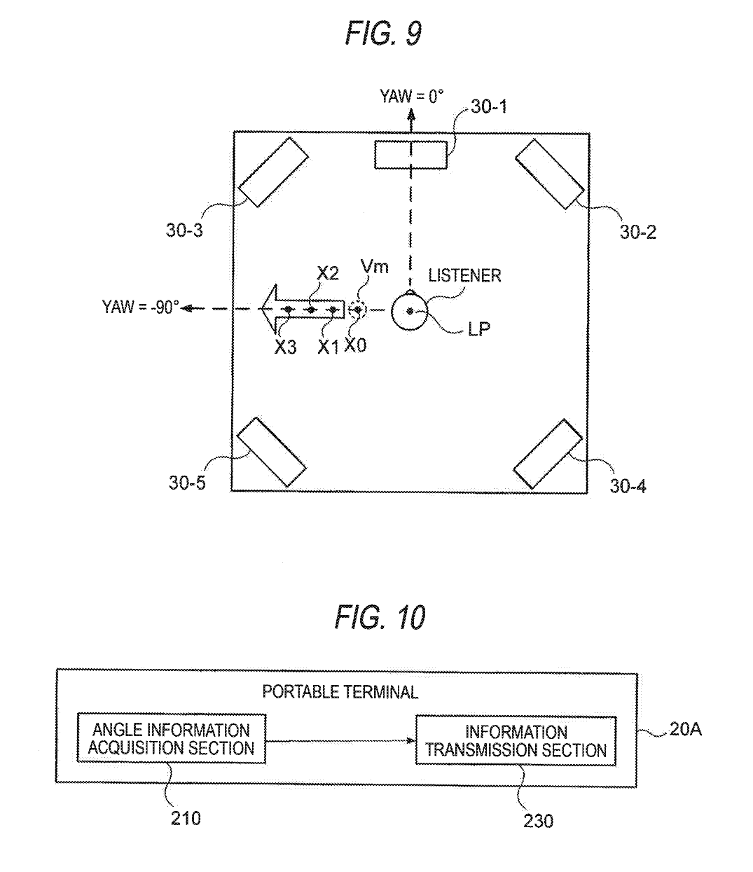

Then, it is assumed that after starting the sound reproduction, an operation for setting the position of the virtual sound source Vm with the Y-axis of the portable terminal 20 pointed toward a position X1 (a position where yaw=−90° and pitch=θ1 (wherein θ0<θ1<−45°)) is performed, then, an operation for setting the position of the virtual sound source Vm with the Y-axis of the portable terminal 20 pointed toward a position X2 (a position where yaw=−90° and pitch=θ2 (wherein θ1<θ2<−45°)) is performed, and thereafter, an operation for setting the position of the virtual sound source Vm with the Y-axis of the portable terminal 20 pointed toward a position X3 (a position where yaw=−90° and pitch=θ3 (wherein θ2<θ3<−45°)) is performed. If the operations for setting the positions X1, X2 and X3 of FIG. 9 as destinations of the movement of the virtual sound source Vm are thus successively performed, the portable terminal 20 transmits, every time such an operation is performed, position information obtained by converting, by the angle/position conversion section 220, the angle information corresponding to its own attitude obtained at the time of performing the operation to the audio amplifier 10 together with a virtual sound source identifier and a channel identifier (or may transmit, as the position information, two-dimensional coordinate information with position information along the Z-axis direction deleted).

On the other hand, in the audio amplifier 10, every time the combination of the virtual sound source identifier, the channel identifier and the position information is received from the portable terminal 20, the stored contents of the virtual sound source management table are updated by the control section 120, the value D(m) is recalculated on the basis of the updated stored contents of the virtual sound source management table, and the value D(m, n) is recalculated on the basis of the stored contents of the loudspeaker management table and the updated stored contents of the virtual sound source management table. Then, the frequency correction section 140-m executes processing for adjusting the intensity of a high frequency component of the audio signal Y-m on the basis of the recalculated value D(m), and the gain distribution section 150-m executes processing for recalculating gain distribution on the basis of the recalculated value D(m, n). As a result, the gain distribution of an audio signal to be supplied to the loudspeaker 30-n is changed over time, and hence, the localized position of a sound image corresponding to the virtual sound source Vm is changed as X0→X1→X2→X3, etc. as illustrated with an arrow in FIG. 9. Besides, since the distance D(m) from the listening point LP to the virtual sound source Vm is changed over time in accordance with the movement of the virtual sound source Vm, the attenuation of the high frequency component of the audio signal to be supplied to the loudspeaker 30-n is also changed over time, and therefore, the virtual sound source Vm can be moved while adding a natural sound effect.

Instead of allowing a user to successively set the destinations of the movement of a virtual sound source through the aforementioned operation performed on the virtual sound source setting screen, with a virtual sound source to be moved precedently determined, the portable terminal 20 may be caused to execute processing for transmitting the virtual sound source identifier, the channel identifier and the position information of this virtual sound source at prescribed time intervals or in response to change occurring in the position information. For enabling such processing, a setting section for allowing a user to set a virtual sound source to be moved, such as an operating element, is first provided in the above-described virtual sound source position setting screen in correspondence with the virtual sound source identifier. Then, after the channel identifier and the installation position of the virtual sound source Vm are set by the above-described operation performed on the virtual sound source position setting screen, if the virtual sound source Vm is specified as a virtual sound source to be moved, the portable terminal 20 is caused to execute processing for writing, in a prescribed memory area in a memory section not shown, the virtual sound source identifier and the channel identifier of the virtual sound source specified by this specifying operation. Thereafter, every time a prescribed time has elapsed, the portable terminal 20 is caused to execute processing for acquiring angle information by the angle information acquisition section 210 and for transmitting, to the audio amplifier 10, position information obtained by converting the angle information by the angle/position conversion section 220 together with the virtual sound source identifier and the channel identifier stored in the memory area. If the prescribed time is set to be sufficiently short in such an aspect, the user can move the virtual sound source without performing an operation for successively specifying positions of the virtual sound source but merely by performing an operation of, for example, waving the portable terminal 20 in such a manner as to trace the positions X0, X1, X2 and X3 of FIG. 9 in this order (namely, an operation for changing the direction of the portable terminal 20 (or the attitude of the portable terminal 20) along the moving route of the virtual sound source).

Alternatively, in response to the operation performed for specifying a virtual sound source to be moved, the virtual sound source identifier and the channel identifier of the virtual sound source are written in the memory area together with the position information of the virtual sound source, and thereafter, the portable terminal 20 is caused to execute processing for acquiring angle information by the angle information acquisition section 210 every time a prescribed time has elapsed, and for determining whether or not new position information obtained by converting the angle information by the angle/position conversion section 220 is different from the position information stored in the memory area, and if the determination result is Yes, the portable terminal 20 may be caused to execute processing for transmitting the new position information and the virtual sound source identifier and the channel identifier stored in the memory area to the audio amplifier 10 for overwriting the position information in the memory area by using the new position information. Also in such an aspect, a user can move a virtual sound source without performing an operation for successively specifying positions of the virtual sound source but merely by performing an operation of waving the portable terminal 20 in such a manner as to trace the moving route of the virtual sound source (or of changing the attitude of the portable terminal 20). Besides, according to this aspect, when the position of the virtual sound source specified to be moved is actually changed, the virtual sound source identifier, the channel identifier and the position information of this virtual sound source are transmitted from the portable terminal 20 to the audio amplifier 10, and therefore, the data traffic between the portable terminal 20 and the audio amplifier 10 can be reduced as compared with the aspect in which the position information is transmitted every time a prescribed time has elapsed.

According to the aspects described above, a user can specify the moving route of a virtual sound source by an intuitive operation of, for example, waving the portable terminal 20 (or changing the attitude of the portable terminal 20). Therefore, for example, in a live performance or the like, if each of singers and musical instrument players is provided with the portable terminal 20 and is allowed to perform an operation for specifying, as a virtual sound source to be moved, a virtual sound source corresponding to his/her own voice or performance sound in his/her portable terminal, each of the singers and musical instrument players can move the virtual sound source corresponding to his/her voice or performance sound merely by, for example, waving the portable terminal 20, and thus, the range of rendering the live performance can be increased. Alternatively, the portable terminal 20 may be constituted so as to be switchable between an operation mode for setting the position of a virtual sound source by an operation performed on the virtual sound source position setting screen and an operation mode for setting the position of a virtual sound source by an operation of, for example, waving the portable terminal 20, so that the portable terminal 20 can be operated in the operation mode specified by a user.

On the side of the audio amplifier 10, the frequency correction section 140-m may be caused to execute processing for reducing the intensity of each frequency component for making the whole gain smaller as the value D(m) corresponding to the distance between the virtual sound source Vm and the listening point LP becomes larger. In the gain adjustment performed by the gain distribution section 150-m (namely, the gain adjustment performed by using the value D(m, n)), it is not possible to express how far the virtual sound source Vm is from the listening point LP, but if the whole gain is adjusted in accordance with the distance between the virtual sound source Vm and the listening point LP, a natural sound effect that, for example, sound becomes smaller as the virtual sound source Vm becomes farther from the listening point LP can be added.

Alternatively, the control section 120 may be caused to detect movement of the virtual sound source Vm depending on whether or not the value D(m) has been updated (or the value D(m, n) has been updated), and if the movement is detected, the gain distribution section 150-m may be caused to execute, under control of the control section 120, processing for smoothly, with a time constant, changing the gain of an audio signal to be supplied to each loudspeaker by, for example, performing LPF processing. Similarly, if the movement of the virtual sound source is detected, the frequency correction section 140-m may be caused to execute processing for smoothly changing the attenuation of a high frequency region (or an adjustment amount of the intensity of each frequency component for volume adjustment). This is because an uncomfortable feeling derived from abrupt change of sound can be reduced through the change with a time constant so that a more natural sound effect can be expected to add. Besides, if the gain of an audio signal to be supplied to each loudspeaker is changed with a time constant, it is particularly effective in a case where the virtual sound source Vm is moved by performing calculation with position information set by a user thinned due to processing load, or in a case where although a plurality of virtual sound sources are instructed to move, all the virtual sound sources cannot be simultaneously moved and hence calculations for moving the virtual sound sources in a time-shifted manner are separately performed. Besides, if a sound volume to be distributed is too small, the processing load can be reduced and the processing can be simplified by regarding the gain as zero so as not to distribute the signal to the loudspeaker. Incidentally, specific examples of the aspect where the movement of the virtual sound source Vm is detected depending on whether or not the value D(m) has been updated (or the value D(m, n) has been updated) include an aspect where the movement of the virtual sound source Vm is detected if the value D(m) or the like has been updated at a frequency beyond a prescribed threshold value within a precedently determined unit time, and an aspect where the movement of the virtual sound source Vm is detected if the update amount of the value D(m) exceeds a prescribed threshold value.

Incidentally, the movement of the virtual sound source is realized by allowing a user to successively set positions for locating the virtual sound source in the present embodiment. However, if a virtual sound source is to be moved along a precedently determined track from an initial position set by a user (such as a straight line passing through the listening point LP and the initial position of the virtual sound source, or a circle centered on the listening point LP and passing through the initial position of the virtual sound source), the user may be caused to set merely a moving direction and a moving rate. This is because if the moving direction and the moving rate are given, the position of the virtual sound source at each time can be calculated. Alternatively, instead of allowing a user to successively set a plurality of positions as the positions for locating a virtual sound source or allowing a user to set a moving track, a moving rate and a moving direction, an audio signal corresponding to the virtual sound source may be analyzed to obtain a moving track, a moving rate and a moving direction, so as to move the virtual sound source in accordance with the analysis result.

### D: Modification

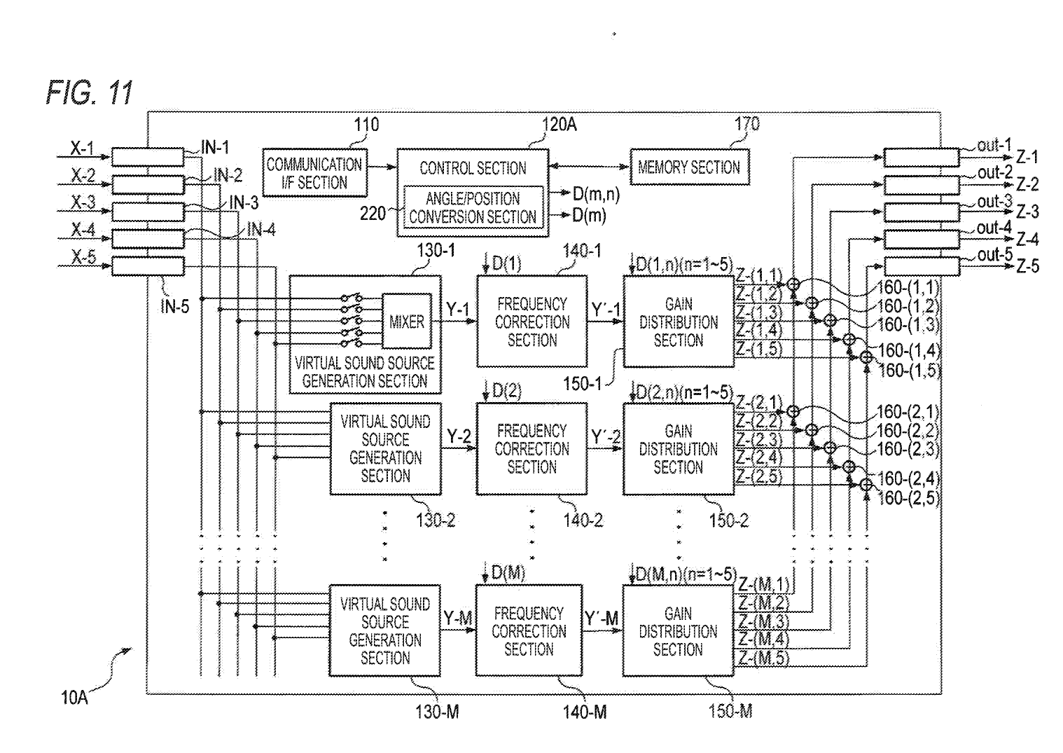

Although the respective embodiments of the present invention have been described so far, it goes without saying that these embodiments may be modified as follows: (1) In each of the above-described embodiments, the portable terminal 20 is caused to execute the processing for transmitting the coordinate information obtained by converting, by the angle/position conversion section 220, the angle information detected by the sensor to the audio amplifier 10 as the position information corresponding to the loudspeaker installation position or the virtual sound source position. The angle information itself may be, however, transmitted from the portable terminal 20 to the audio amplifier 10 as the position information, and the control section 120 of the audio amplifier 10 may be caused to execute processing for calculating the coordinate information based on this angle information. Specifically, an audio system is constituted by a portable terminal 20A configured without using the angle/position conversion section 220 as illustrated in FIG. 10 and an audio amplifier 10A configured by providing, instead of the control section 120, a control section 120A including the angle/position conversion section 220 as illustrated in FIG. 11. In this case, the information transmission section 230 of the portable terminal 20A plays a role as a position information provider, and the communication I/F section 110 and the control section 120A of the audio amplifier 10A play a role as position information acquirer (a position information acquirer that converts angle information received from the portable terminal 20A into coordinate information corresponding to a position on a boundary of a coordinate space having the position of the portable terminal 20A as the origin and having a prescribed size orthogonally to the vertical axis, and outputs the coordinate information as the position information). In the audio system thus constituted, if an operation for setting a loudspeaker position is performed, the portable terminal 20A transmits a combination of a loudspeaker identifier and angle information obtained at the time of performing the operation to the audio amplifier 10A, and if an operation for setting a virtual sound source position is performed, the portable terminal 20A transmits, to the audio amplifier 10A, a combination of a virtual sound source identifier, a channel identifier of a channel for generating a virtual sound source and angle information obtained at the time of performing the operation. The control section 120A of the audio amplifier 10A executes processing for converting the angle information received from the portable terminal 20A into position information by the angle/position conversion section 220. In such an aspect, any terminal can be used as the portable terminal 20A as long as it includes a sensor such as a gyro sensor or an acceleration sensor, a user interface for allowing a user to set the position of a loudspeaker or a virtual sound source, and an information transmission section. Besides, in each of the above-described embodiments, the frequency correction section 140-m is provided at a stage previous to the gain distribution section 150-m, but the frequency correction section 140-m may be provided at a stage subsequent to the gain distribution section 150-m.

(2) In each of the above-described embodiments, the exemplified application of the present invention to what is called a 5.1-channel surround system is described. The present invention is, however, applicable to a 2.1-channel, 7.1-channel or 9.1-channel surround system, or applicable to a surround system including no subwoofer or a plurality of subwoofers. As the essential point, if the present invention is applied to any audio system in which a plurality of loudspeakers are included and one or a plurality of virtual sound sources are set (a sound image corresponding to each sound source is localized) by using sounds respectively output from the plurality of loudspeakers, the virtual sound sources can be located in positions desired by a user, or can be moved while adding a natural effect.

(3) In each of the above-described embodiments, a user is allowed to set the installation position of each of the loudspeakers 30-n (n=1 to 5) by the operation of the portable terminal 20. On the contrary, a GPS receiver and a transmitter for transmitting position information received by the GPS receiver to the audio amplifier 10 may be attached to (or contained in) each of the loudspeakers 30-n (n=1 to 5) and the portable terminal 20, and the control section 120 of the audio amplifier 10 may be caused to execute processing for calculating, on the basis of the information transmitted from the transmitter, position information corresponding to the installation position of each loudspeaker in a coordinate space with a prescribed size having the position of the listening point as the origin and for writing the calculated position information in the memory section 170. In such an aspect, there is no need to make a user set the position of each of the loudspeakers 30-n (n=1 to 5).

(4) In each of the above-described embodiments, the description is given on a case where one portable terminal 20 is used for setting the position of each of a plurality of virtual sound sources. Instead, a portable terminal used for setting the installation position may be determined for each of virtual sound sources, so that the installation positions of the plural virtual sound sources may be set respectively by using a plurality of portable terminals. For example, with a portable terminal 20-1 used for setting the installation position of a virtual sound source V1, with a portable terminal 20-2 used for setting the installation position of a virtual sound source V2, etc. and with a portable terminal 20-m used for setting the installation position of a virtual sound source VM, the audio amplifier 10 may be caused to execute processing for distributing an audio signal to be supplied to the loudspeaker 30-n (n=1 to 5) on the basis of position information received from the portable terminal 20-m so that a sound image corresponding to a virtual sound source Vm (m=1 to M) can be localized in a position set by the portable terminal 20-m.

The embodiments of the present invention will be summarized as follows:

The present invention provides an audio signal processing device including: a calculator for generating a plurality of audio signals to be supplied respectively to a plurality of loudspeakers on the basis of an audio signal corresponding to a virtual sound source and having position information, in which the calculator calculates, on the basis of the position information indicating a position of the virtual sound source and loudspeaker position information indicating positions of the plurality of loudspeakers, a distance between each of the plurality of loudspeakers and the virtual sound source with respect to each of the plurality of loudspeakers, and calculates, on the basis of the distance, the audio signal corresponding to the virtual sound source to be supplied to each of the plurality of loudspeakers.

For example, the calculator executes a processing for calculating a distribution amount of the audio signal corresponding to the virtual sound source so that a gain is smaller in the audio signal to be supplied to a loudspeaker, among from the plurality of loudspeakers, located in a position farther from a position indicating the position information of the position of the virtual sound source taken from a listening point corresponding to a position of a listener, and generates the audio signal to be supplied to each of the plurality of loudspeakers in accordance with the distribution amount.

For example, the audio signal processing device further includes an acquirer for acquiring the position information indicating the position of the virtual sound source through communication with a portable terminal that transmits the position information in response to an operation performed for setting the position of the virtual sound source, or every time a prescribed time has elapsed, or every time the position information is changed, and the calculator calculates the distribution amount of the audio signal corresponding to the virtual sound source in response to acquisition of the position information by the acquirer.

For example, the acquirer acquires, through communication with the portable terminal, position information indicating a position of each of the plurality of loudspeakers taken from the listening point.

For example, a terminal device including a sensor for detecting its own attitude (such as a gyro sensor or an acceleration sensor), like a smart phone, can be used as the portable terminal. As a specific method for setting the position of a virtual sound source by using such a portable terminal, the portable terminal is caused to execute processing for converting angle information, which corresponds to an attitude of the terminal itself at a time of performing a prescribed operation with the portable terminal pointed toward a position desired to locate the virtual sound source, into coordinate information corresponding to a position in a coordinate space, and transmitting the coordinate information, as the position information, to the audio signal processing device (such as an audio processor, BD (Blu-ray Disc (registered trademark)/DVD (Digital Versatile Disc) player integrated amplifier having an audio amplifier function, a digital signal processing function and a preamplifier function), or processing for transmitting the angle information to the audio signal processing device as the position information. In the former aspect, the above-described calculator may be caused to execute the calculation of the distribution amount on the basis of the position information received from the portable terminal and processing for generating the audio signal to be supplied to each of the loudspeakers on the basis of the distribution amount. In the latter aspect, the above-described calculator may be caused to execute the calculation of the distribution amount after converting the position information (angle information) received from the portable terminal into coordinate information and the processing for generating the audio signal to be supplied to each of the loudspeakers on the basis of the distribution amount. In this manner, according to the present invention, a virtual sound source can be located in a position desired by a user by such an intuitive and easy to understand operation that a prescribed operation is performed with the portable terminal pointed toward a position desired to locate the virtual sound source. Besides, if the portable terminal is caused to execute the processing for transmitting the position information corresponding to the installation position of a virtual sound source at prescribed time intervals or the processing for transmitting the position information every time the position of the virtual sound source is changed, the installation position of the virtual sound source can be moved on a real time basis by smoothly changing the attitude of the portable terminal. It is noted that although Patent Document 1 discloses a technique for allowing a user to set the size and articulation of a sound image, this is not a technique for setting a virtual sound source in a desired position by an intuitive operation and is completely different from the present invention.

Here, with respect to the positions of the plural speakers, the position information corresponding to their installation positions may be precedently stored in the audio signal processing device by, for example, inputting numerical values, or a user may be allowed to set the installation position of each loudspeaker by a method similar to that employed for setting the virtual sound source position. In this aspect, the installation position of the loudspeaker can be also set by an intuitive and easy to understand operation.

For example, the audio signal processing device includes an adjuster for performing a signal processing for adding a sound effect in accordance with a distance in the coordinate space between the virtual sound source and the listening point to an audio signal to be input to the calculator or to an audio signal to be output from the calculator to each of the plurality of loudspeakers. In this aspect, attenuation of a high frequency region caused by the space can be virtually realized by, for example, increasing the attenuation of a high frequency component as the virtual sound source is farther from the listening point, and thus, sound with a higher sense of presence can be reproduced. Besides, for example, a processing for adjusting intensity of each frequency component so that a sound volume is reduced or the attenuation of a high frequency component is increased as the distance in the coordinate space between the virtual sound source and the listening point is larger is employed as the signal processing, and the audio signal processing device is provided with a detector for detecting movement of a virtual sound source, and if the movement of the virtual sound source is detected by the detector, the calculator executes a processing for smoothly changing the distribution amount to each of the plurality of loudspeakers and the adjuster that executes a processing for smoothly changing the adjustment amount of the intensity of each frequency component. In this aspect, the sound can be avoided from intermittently changing through the movement of the virtual sound source, and the virtual sound source can be moved while adding a more natural sound effect.

For example, the acquirer is caused to acquire position information of each of a plurality of virtual sound sources from each of a plurality of portable terminals precedently determined respectively as settlers for positions of the virtual sound sources, and the calculator is caused to generate the audio signal to be supplied to each of the plurality of loudspeakers with respect to each of the plurality of virtual sound sources on the basis of the position information acquired from each of the plurality of portable terminals determined respectively as the settlers of the positions of the virtual sound sources.

Besides, the present invention provides a position information acquisition device including an angle information provider for detecting a rotation angle around a vertical axis based on a direction along one of two axes orthogonal to the vertical axis, and outputting angle information indicating the rotation angle; and a position information provider for executing processing for outputting position information indicating a position on a boundary of a two-dimensional coordinate space, which has a position of the angle information provider as an origin and has a prescribed size orthogonally to the vertical axis, on the basis of the angle information output by the angle information provider every time an operation for instructing position setting is performed, every time a prescribed time has elapsed, or every time the position information is changed.

If this position information acquisition device is used as a terminal for setting a position desired to locate a virtual sound source or an installation position of a loudspeaker in an audio signal processing device (such as an audio amplifier), and a person moves to a listening point with the terminal possessed and performs such an intuitive and easy to understand operation of performing an operation for instructing the position setting (of, for example, pressing a prescribed operating element) with the terminal pointed toward a position desired to locate the virtual sound source or toward the loudspeaker, the installation position of the loudspeaker or the position of the virtual sound source can be set in the audio signal processing device. Incidentally, specific examples of the angle information provider may include a gyro sensor, a triaxial acceleration sensor and a combination of these, and a portable terminal such as a smart phone may be used as the position information acquisition device. This is because such a portable terminal usually contains a gyro sensor or a triaxial acceleration sensor. Although Patent Document 1 discloses a technique for allowing a user to set the size and articulation of a sound image, this is not a technique for allowing a user to set a localization position of a sound image by an intuitive and easy to understand operation and is completely different from the present invention.

For example, the position information provider is caused to execute processing for converting the angle information output by the angle information provider into coordinate information indicating a position on the boundary of the two-dimensional coordinate space and outputting the coordinate information as the position information. In another aspect, the angle information provider executes a processing for detecting a first rotation angle around the vertical axis of the position information acquisition device and a second rotation angle around one of the two axes orthogonal to the vertical axis, and outputs angle information indicating the first and second rotation angles, and the position information provider converts the angle information output by the angle information provider into coordinate information indicating a position on a boundary of a three-dimensional coordinate space, which has a position of the position information acquisition device as an origin and has a prescribed size in a height direction along the vertical axis, and outputs the coordinate information as the position information. Incidentally, a position along the height direction in the three-dimensional coordinate space may be calculated on the basis of the second rotation angle corresponding to the angle information. In this aspect, the installation position of a loudspeaker or the position desired to locate a virtual sound source can be set also in consideration of the height direction.

For example, an operating element allows a user to instruct reset of a rotation angle is provided in the position information acquisition device, and the angle information provider is caused to execute processing for resetting the rotation angle to zero in response to instruction of reset of the rotation angle by an operation performed on the operating element. In this aspect, a rotation angle can be simply reset by operating the operating element with the position information acquisition device pointed in a given direction so that the rotation angle obtained when the position information acquisition device is pointed in the given direction can be zero.

The conversion of the angle information into the coordinate information may be performed in the audio amplifier. For example, the present invention provides an audio signal processing system including a portable terminal for detecting a rotation angle around a vertical axis based on a direction along one of two axes orthogonal to the vertical axis and outputting the rotation angle as angle information; and an audio signal processing device including a position information acquirer for acquiring position information corresponding to a position of a virtual sound source taken from a listening point corresponding to a position of a listener set as a position of the portable terminal, and calculator that is means for generating an audio signal to be supplied to each of a plurality of loudspeakers on the basis of an audio signal corresponding to the virtual sound source and outputting the audio signal, and executes, in response to acquisition of the position information by the acquirer, processing for calculating a distribution amount of the audio signal corresponding to the virtual sound source in such a manner that a gain is smaller, in accordance with a position, in an audio signal to be supplied to a loudspeaker located in a position farther from a position corresponding to the position information, and generates the audio signal to be supplied to each loudspeaker in accordance with the distribution amount, in which the portable terminal executes processing for transmitting the angle information to the audio signal processing device as information corresponding to the position of the virtual sound source every time an operation for setting the position of the virtual sound source is performed, every time a prescribed time has elapsed, or every time the angle information is changed, the position information acquirer is a communication section for communicating with the portable terminal, converts the angle information received from the portable terminal into coordinate information corresponding to a position on a boundary of a two-dimensional coordinate space having a position of the portable terminal as an origin and having a prescribed size orthogonally to the vertical axis, and outputs the coordinate information as the position information, and the calculator calculates, on the basis of the position information output from the position information acquirer, a distance between the virtual sound image and each of the plurality of loudspeakers, and calculates a distribution amount of the audio signal corresponding to the virtual sound source in accordance with the distance between the virtual sound image and each of the plurality of loudspeakers. Also in this audio signal processing system, a user can be allowed to set the position of a virtual sound source and the like by an intuitive and easy to understand operation.

The present invention has been described in detail with reference to specific embodiments thereof, and it will be apparent for those skilled in the art that various changes and modifications can be made without departing from the spirit, the scope or the intention of the present disclosure.

The present invention is based upon a Japanese patent application (Japanese Patent Application No. 2012-252523) filed on Nov. 16, 2012 and a Japanese patent application (Japanese Patent Application No. 2012-260386) filed on Nov. 28, 2012, the entire contents of which are incorporated herein by reference.

### INDUSTRIAL APPLICABILITY

According to the present invention, an installation position of a loudspeaker or a position of a virtual sound source can be set in an audio signal processing device by performing an intuitive and easy to understand operation.

### REFERENCE SIGNS LIST

1 . . . audio system (audio signal processing system), 10, 10A . . . audio amplifier (audio signal processing device), IN-k (k=1 to 5) . . . audio input terminal, OUT-n (n=1 to 5) . . . audio output terminal, 110 . . . communication I/F section, 120, 120A . . . control section, 130-m (m=1 to M) . . . virtual sound source generation section, 140-m (m=1 to M) . . . frequency correction section, 150-m (m=1 to M) . . . gain distribution section, 160-(m, n) (n=1 to 5, m=1 to M−1) . . . adder, 170 . . . memory section. 20, 20A . . . portable terminal. 210 . . . angle information acquisition section. 220 . . . angle/position conversion section, 230 . . . information transmission section, 30-n (n=1 to 5) . . . loudspeaker

1. An audio signal processing device comprising:
a calculator that generates a plurality of audio signals to be supplied respectively to a plurality of loudspeakers on the basis of an audio signal corresponding to a virtual sound source and having position information,
wherein the calculator calculates, on the basis of the position information indicating a position of the virtual sound source and loudspeaker position information indicating positions of the plurality of loudspeakers, a distance between each of the plurality of loudspeakers and the virtual sound source with respect to each of the plurality of loudspeakers, and calculates, on the basis of the distance, the audio signal corresponding to the virtual sound source to be supplied to each of the plurality of loudspeakers.

2. The audio signal processing device according to claim 1, wherein the calculator executes a processing for calculating a distribution amount of the audio signal corresponding to the virtual sound source so that a gain is smaller in the audio signal to be supplied to a loudspeaker, among from the plurality of loudspeakers, located in a position farther from a position corresponding to the position information indicating the position of the virtual sound source taken from a listening point corresponding to a position of a listener, and generates the audio signal to be supplied to each of the plurality of loudspeakers in accordance with the distribution amount.

3. The audio signal processing device according to claim 2, further comprising:
an acquirer that acquires the position information indicating the position of the virtual sound source through communication with a portable terminal that transmits the position information in response to an operation performed for setting the position of the virtual sound source, or every time a prescribed time has elapsed, or every time the position information is changed,
wherein the calculator calculates the distribution amount of the audio signal corresponding to the virtual sound source in response to acquisition of the position information by the acquirer.

4. The audio signal processing device according to claim 3, wherein the acquirer acquires, through the communication with the portable terminal, position information indicating a position of each of the plurality of loudspeakers taken from the listening point.

5. The audio signal processing device according to claim 2, further comprising:
an adjuster that performs a signal processing for adding a sound effect in accordance with a distance, in a coordinate space, between the virtual sound source and the listening point, to an audio signal to be input to the calculator or to an audio signal to be output from the calculator to each of the plurality of loudspeakers.

6. The audio signal processing device according to claim 5, wherein the signal processing is a processing for adjusting intensity of each frequency component so that a sound volume is reduced or attenuation of a high frequency component is increased as the distance in the coordinate space between the virtual sound source and the listening point is larger, and
the audio signal processing device further comprising:
a detector that detects movement of a virtual sound source, and if the movement of the virtual sound source is detected by the detector, the calculator executes a processing for smoothly changing the distribution amount to each of the plurality of loudspeakers, and the adjuster executes a processing for smoothly changing the adjustment amount of the intensity of each frequency component.

7. The audio signal processing device according to claim 3, wherein the acquirer acquires position information of each of a plurality of virtual sound sources from each of a plurality of portable terminals precedently determined respectively as settlers for positions of the virtual sound sources; and
wherein the calculator generates the audio signal to be supplied to each of the plurality of loudspeakers with respect to each of the plurality of virtual sound sources on the basis of the position information acquired from each of the plurality of portable terminals determined respectively as the settlers of the positions of the virtual sound sources.

8. A position information acquisition device comprising:
an angle information provider that detects a rotation angle around a vertical axis based on a direction along one of two axes orthogonal to the vertical axis, and outputs angle information indicating the rotation angle; and
a position information provider that executes a processing for outputting position information indicating a position on a boundary of a two-dimensional coordinate space, which has a position of the angle information provider as an origin and has a prescribed size orthogonally to the vertical axis, on the basis of the angle information output by the angle information provider every time an operation for instructing position setting is performed, every time a prescribed time has elapsed, or every time the position information is changed.

9. The position information acquisition device according to claim 8, wherein the position information provider converts the angle information output by the angle information provider into coordinate information indicating the position on the boundary of the two-dimensional coordinate space and outputs the coordinate information as the position information.

10. The position information acquisition device according to claim 9, wherein the angle information provider detects a first rotation angle around the vertical axis of the position information acquisition device and a second rotation angle around one of the two axes orthogonal to the vertical axis, and outputs angle information indicating the first and second rotation angles; and
wherein the position information provider converts the angle information output by the angle information provider into coordinate information indicating a position on a boundary of a three-dimensional coordinate space, which has a position of the position information acquisition device as an origin and has a prescribed size in a height direction along the vertical axis, outputs the coordinate information as the position information, and calculates a position coordinate in the height direction on the basis of the second rotation angle indicating the angle information.

11. The position information acquisition device according to claim 8, further comprising:
an operating element that allows a user to instruct reset of the rotation angle,
wherein the angle information provider resets the rotation angle of the position information acquisition device around the vertical axis to zero in response to instruction of the reset of the rotation angle by an operation performed on the operating element.

12. An audio signal processing system comprising:
a portable terminal that detects a rotation angle around a vertical axis based on a direction along one of two axes orthogonal to the vertical axis and outputs the rotation angle as angle information; and
an audio amplifier including:
a position information acquirer that acquires position information indicating a position of a virtual sound source taken from a listening point corresponding to a position of a listener set as a position of the portable terminal; and
an calculator that generates an audio signal to be supplied to each of a plurality of loudspeakers on the basis of an audio signal corresponding to the virtual sound source and outputs the audio signal, and executes, in response to acquisition of the position information by the acquirer, a processing for calculating a distribution amount of the audio signal corresponding to the virtual sound source so that a gain is smaller, in accordance with a position of the loudspeaker, in an audio signal to be supplied to a loudspeaker located in the position farther from a position indicated by the position information, and generates the audio signal to be supplied to each of the plurality of loudspeakers in accordance with the distribution amount,
wherein the portable terminal executes a processing for transmitting the angle information to the audio amplifier as information indicating the position of the virtual sound source every time an operation for setting the position of the virtual sound source is performed, every time a prescribed time has elapsed, or every time the angle information is changed;
wherein the position information acquirer is a communication section that communicates with the portable terminal, converts the angle information received from the portable terminal into coordinate information indicating a position on a boundary of a two-dimensional coordinate space having a position of the portable terminal as an origin and having a prescribed size orthogonally to the vertical axis, and outputs the coordinate information as the position information; and
wherein the calculator calculates, on the basis of the position information output from the position information acquirer, a distance between the virtual sound source and each of the plurality of loudspeakers, and calculates a distribution amount of the audio signal corresponding to the virtual sound source in accordance with the distance between the virtual sound source and each of the plurality of loudspeakers.
